(19) United States
(12) Patent Application Publication
(10) Pub. No.: US 2004/0256494 A1
(43) Pub. Date: Dec. 23, 2004

(54) Outwardly-opening fuel injector

(76) Inventors: Daniel L. Varble, Henrietta, NY (US); Edward S. Suh, Rochester, NY (US); Gail E. Geiger, Caledonia, NY (US); Sudhakar Das, Rochester, NY (US)

Correspondence Address: Patrick M. Griffin, Esq., Delphi Technologies, Inc., P.O. Box 5052, Mail Code 480410202, Troy, MI, 48007, US

(21) Appl. No.: 10/453,000

(22) Filed: Jun. 3, 2003

(51) Int. Cl. B05B 1/30

(52) U.S. Cl. 239/533.2

(57) ABSTRACT

An outwardly-opening fuel injector including a conical valve seat and conical valve head having nominally identical cone angles and mating lengths along the conical frustum between about 0.25 mm and about 0.30 mm. One of either the seat surface or the head surface is provided with an annular undercut to limit the length of mating contact to the desired range. The mating lengths and seal areas remain constant with use because the undercut prevents further changes in mating length. The resulting seal area prevents recession of the head into the seat with use, and therefore the valve stroke is predictable and constant. Further, the undercut provides a sharp corner in the fuel flow path downstream of the seal area, which increases the turbulent kinetic energy of fuel being discharged as a spray cone.

### TECHNICAL FIELD

The present invention relates to direct injection fuel injectors; more particularly, to such fuel injectors which open outwardly; and most particularly, to such a fuel injector having an improved, long-wearing valve head and seat arrangement that provides a stable spray cone and increased turbulent kinetic energy (TKE) in the fuel spray.

### BACKGROUND OF THE INVENTION

Outwardly-opening fuel injectors are well known for use in injecting fuel into the combustion cylinders of internal combustion engines. Such injection is known in the art as “direct injection” as opposed to “port injection” wherein fuel is injected into a manifold port upstream of the cylinder's intake valve.

An especially demanding use of direct injection is for injection of gasoline into spark-ignited internal combustion engines. Engine manufacturers are now recognizing that so-called “spray guided” fuel injectors can be important factors in meeting fuel emission and fuel economy standards. Spray guided means that the fuel is injected into the combustion chamber and presented to the spark plug for ignition as an atomized fuel cloud having the proper location, size, and shape. The actual combustion chamber itself is not required to deflect, relocate, or prepare the fuel for ignition. For spray guided combustion, it is very important that the spray geometry remains consistent throughout a wide range of engine operating conditions. A known method of achieving the spray guided function is to cause the fuel injector to open outwardly into the firing chamber and to use the valve head and/or valve seat (referred to herein as a “metering assembly”) to shape and direct the charge of fuel exiting the injector.

A prior art outward-opening fuel injector employs a fixed conical seat and a conical valve head. The cone angle of the seat differs from the cone angle of the valve head by, typically, about two degrees. This mismatch provides a predictable seal diameter, along a circular seal line, when the valve is closed. This is important, as the injector relies for correct action on a force balance of fuel pressure and an internal spring. This angle mismatch is also robust to slight manufacturing variation in pintle and seat angles.

Another important consideration for a prior art fuel injector is exit diameter of the spray cone. A spray cone includes inner and outer vortices, and when the exit diameter is too small, the vortices interact, causing the spray cone to collapse. Unfortunately, as the exit diameter is increased to stabilize the spray cone, fuel atomization quality diminishes because velocity of the fuel after the throat area decreases as the frustum area expands.

An additional problem with a prior art fuel injector having a line seal because of intentional angle mismatch between the seat and head as described above is that the mismatch angle and resulting seal line in the valve seat puts a sharp stress line on the seat, which accelerates wear thereof. With use, the sealing contact line between seat and head becomes blurred into an ill-defined sealing area; and worse, the head recesses into the seat. Such wear can lead to leakage, but more importantly, it changes the stroke of the injector and the force balance. It has been found that the contact area grows relatively quickly with use until equilibrium is reached at an interface length along the cone frustum. As the contact area grows, wear rate diminishes proportionally as the unit impact forces are reduced. This process continues over many millions of cycles, which is far too long for a factory burn-in procedure prior to installation of a fuel injector, but is far less than the 630 million cycle expected working life of a fuel injector.

Further, the enlarged contact area along the frustum produces a larger force on the valve head, which also changes the dynamic response times.

Further, as the valve head recesses into the seat and the length of the valve stroke changes, the magnetic air gaps in the solenoid actuator are also changed. An enlarged air gap in the lower (opening) solenoid reduces the force that it is capable of producing and changes the dynamic response times. When the air gap in the upper (closing) solenoid approaches zero, the injector may stick closed due to residual magnetism, or due to hydraulic sticktion caused by a film of liquid fuel formed between the mating faces of the armature and coil. In an extreme case, the armature will hit the upper pole, causing the injector to bounce upon closing. The change in stroke has been found to be typically about 20% of the initial stroke, which is approximately the same as the initial upper air gap.

What is needed in the art is a dual-coil, outwardly-opening fuel injector having a fixed area of contact between the seat and the valve head.

What is further needed in the art is such a fuel injector which imparts a higher level of turbulent kinetic energy to fuel being discharged.

It is a principal object of the present invention to provide a predictable, constant, non-collapsing spray cone of fuel having a high level of turbulent kinetic energy.

### SUMMARY OF THE INVENTION

Briefly described, an outwardly-opening fuel injector includes a conical valve seat and conical valve head having nominally identical cone angles and mating lengths along the conical frustum. Preferably, the mating lengths are between about 0.25 mm and about 0.30 mm, which are the lengths and corresponding mating areas that prior art fuel injectors have shown to be stable after extensive wear-in. One of either the seat surface or the head surface is provided with an annular undercut to limit the length of contact to the desired range. Because the seal surfaces are substantially parallel at manufacture, the surfaces can wear-in against each other quickly with use, and any resulting changes in seal diameter and valve stroke are trivial. The seal lengths and areas remain constant with use because the undercut prevents further changes in seal length. The resulting seal area has been shown to be large enough to prevent recession of the head into the seat, and therefore, the valve stroke is predictable and constant with use. Further, the undercut provides a sharp corner in the fuel flow path downstream of the seal area, which increases the turbulent kinetic energy of fuel being discharged as a spray cone.

### BRIEF DESCRIPTION OF THE DRAWINGS

The present invention will now be described, by way of example, with reference to the accompanying drawings, in which:

FIG. 1 is an elevational cross-sectional view of a prior art outwardly-opening fuel injector;

FIG. 2 is a detailed elevational cross-sectional view of the prior art fuel injector shown in FIG. 1, taken in Circle 2 in FIG. 1 and showing the valve seat and head in the valve open position;

FIG. 3 is a view like that shown in FIG. 2, showing the valve seat and head in the valve closed position;

FIG. 4 is a detailed elevational cross-sectional view of a first embodiment of an improved fuel injector valve seat and head in accordance with the invention, showing the valve seat and head in the valve open position;

FIG. 5 is a view like that shown in FIG. 4, showing the valve seat and head in the valve closed position; and

FIG. 6 is a cross-sectional view of a second embodiment of a valve seat and head in accordance with the invention.

### DESCRIPTION OF THE PREFERRED EMBODIMENTS

The novelty and advantages conferred by the invention may be better appreciated by first considering a prior art dual-coil outwardly-opening fuel injector. While a dual coil injector is depicted herein, it is understood that the invention is equally suitable for use in an outwardly opening injector having any number of coils.

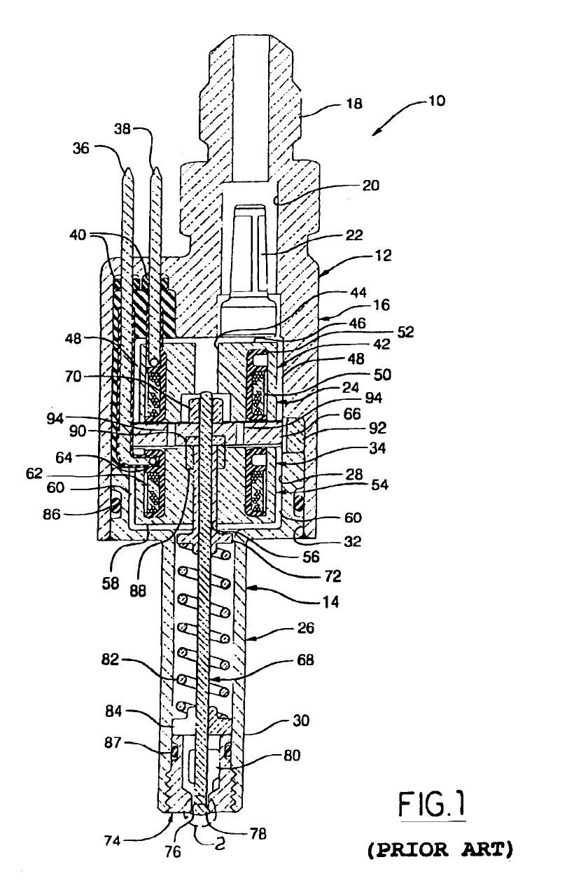

Referring to FIGS. 1, 2, and 3, a prior art fuel injector 10 is formed from two assemblies, including an upper housing assembly 12 and a lower housing assembly 14. The upper housing assembly 12 includes an upper housing 16 having an inlet defined by a threaded fuel fitting 18 and communicating through an inlet passage 20 containing a fuel filter 22 with a chamber or recess containing an upper solenoid assembly 24.

Lower housing assembly 14 includes a lower housing 26 having an enlarged upper portion 28 and a smaller diameter tubular lower portion 30. The upper portion has an outer diameter that is received in a generally cylindrical recess 32 formed in the lower portion of upper housing 16. In the example shown, a lower solenoid assembly 34 is received in an upwardly opening recess of the lower housing upper portion 28. Terminals 36,38 extend upward from the lower and upper solenoids 24,34 respectively through openings in the upper housing 16 which are sealed by O-ring seals 40.

The upper solenoid assembly 24 includes a generally cylindrical upper soft (not permanently magnetized) magnetic pole 42 with a central axial passage 44 and a radial or transverse upper groove 46, both connecting with the fuel inlet passage 20. Groove 46 further connects with longitudinally extending external side grooves 48 leading to the lower end of the pole. An annular recess, opening to the lower end of pole 42, receives an upper solenoid coil 50 wound on a non-magnetic bobbin 52 having an annular upper groove for connection of the coil with its terminals 38.

The lower solenoid assembly 34 also includes a generally cylindrical lower soft magnetic pole 54 having an axial central bore 56 and a radial or transverse groove 58 across its lower side and connecting with external longitudinal side grooves 60 extending to the upper end of the pole. An upwardly opening annular recess in the pole 54 receives a lower solenoid coil 62 also wound on a non-magnetic bobbin 64 having an upper groove for connecting the coil through a slot in the side of the bobbin with the terminals 36 leading from the lower coil.

Located between the magnetic poles 42,54 is a disc-like armature 66 also formed of a soft magnetic material. The armature 66 has a central opening through which extends a pintle 68 having a retaining nut 70 threaded onto one end of the pintle. The nut 70 holds the armature 66 against the upper end of a tubular portion of a spring upper guide 72. The armature 66, pintle 68, pintle nut 70, and guide 72 form an armature assembly, the parts of which are fixed together by the nut for movement in unison.

Guide 72 acts as a tubular valve guide for the upper end of the pintle 68 which extends therethrough and beyond to the lower end of the lower portion 30 of the lower housing 26. An injector nozzle 74 is threadably mounted in the lower end of lower portion 30 and has a centrally located outwardly opening conical valve seat 76 which is engageable by a conical valve head 78 formed on the lower end of the pintle which acts as a pintle valve. A swirl generator 80 is located around the pintle within the injector nozzle 74 defining therewith passages which impart a swirl motion to fuel passing therethrough toward the valve seat 76. The lower end of the spring upper guide 72 forms a spring seat for a helical return spring 82 which extends downward in the lower portion 30 of the lower housing to a lower spring guide 84 that seats against the injector nozzle 74. During assembly, the spring is compressed to the desired force and the upper guide 72 is then welded to the pintle to maintain the return spring force.

Additional components of the injector 10 include a housing seal 86 and an injector nozzle seal 87 to prevent leakage of fuel from the housing 16,18. The pintle retaining nut 70 is received in a recess in the lower end of the upper pole 42 and forming a part of the axial passage 44. A similar recess in the upper end of the lower pole 54 receives a hardened stop 88 which is engaged by an armature stop 90 to provide a predetermined gap or clearance between the armature 66 and the lower pole 54 when the stops are engaged. The armature stroke is set by turning the threaded nozzle 74 with the valve closed until the spacing of the armature from the stop 88 is equal to the desired stroke. A spacer ring 92 is located between the upper end of the lower housing 26 and a downwardly facing annular abutment in the recess 32 of the upper housing 16. The spacer ring 92 is sized longitudinally after setting the stroke to provide a predetermined clearance or gap between the armature and the upper magnetic pole when the valve 78 is closed. Relief holes 94 extend axially through armature 66 to prevent hydraulic damping of armature motion by the fuel in which it is immersed.

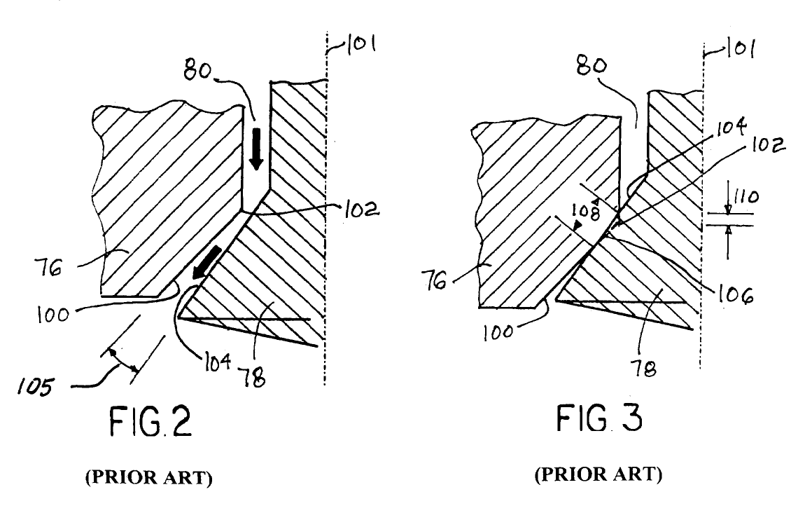

Referring now to FIGS. 2 and 3, in prior art fuel injector 10, valve seat 76 has a first conical sealing surface 100 concentric with valve centerline 101, terminating in an upper corner 102 where sealing surface 100 meets the lower end of fuel swirl generator 80. Valve head 78 has a second conical sealing surface 104. Surfaces 100 and 104 are non-parallel but rather have a manufactured angle 106 between them, typically about 2°, as shown in FIG. 2., such that when valve head 78 is closed against seat 76, corner 102 engages surface 104 in a clearly defined circular seal line. As discussed above, and referring now to FIG. 3, in a period of time far less than the desired working lifetime of the fuel injector, corner 102 typically is worn off by surface 104. As the wear continues during use, a mating surface 106 of irregular shape and length 108 gradually forms between the head and seat at some conical angle which may be other than the initial angle of surface 100. As the surface 106 lengthens, the load-bearing seal area increases and the rate of wear slows, eventually equilibrating at a length 108 between about 0.25 mm and about 0.30 mm. As discussed above, a significant drawback of such wear-in is that the stroke of the head pintle is changed as the head recesses into the seat, by a distance 110 which markedly affects the response and force of both upper solenoid assembly 24 and lower solenoid assembly 34 (FIG. 1). Thus the functionality of the fuel injector is impaired in a) the size and form of spray cone being ejected across wear surface 106; b) the opening response of the injector; and c) the closing response of the injector. In sum, prior art injector 10 can become unpredictable and sub-optimal for as much as about 85% of its intended useful lifetime following the wear period in which the head recesses into the seat.

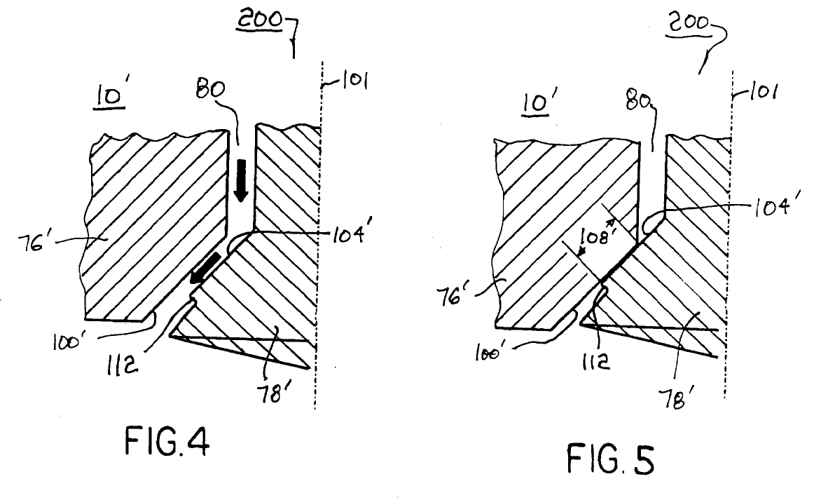

Referring to FIGS. 4 and 5, a first embodiment 200 of an improved metering assembly for an outwardly-opening fuel injector metering seat and head is shown. Improved seat sealing surface 100′ and improved valve head sealing surface 104′ are formed to be substantially parallel, that is, having the same conical angle about valve centerline 101. When manufacturing variability prevents the surfaces from being perfectly parallel upon assembly, the surfaces will wear-in to parallelism very quickly. As head 78′ is moved axially into closing (sealing) position as shown in FIG. 5, surface 100′ and surface 104′ are engaged over a length 108′ which is governed by the placement of an annular notch or setback 112 formed in head surface 104′. Setback 104′ limits the frustum length of surface 104′ such that the interface sealing length 108′ is between, preferably, about 0.25 mm and about 0.30 mm, as was shown above to be an empirically determined stable length wherein the valve head is substantially at equilibrium with respect to wearing into the valve seat. However, if some very slow wear does continue, the length 108 of the contact between the head and seat remains constant because of undercut 112.

The novel arrangement just described is superior to the prior art arrangement for at least four reasons: a) the seal length, and hence the seal area, remains constant and predictable over the lifetime of the fuel injector; b) the solenoid performance is unchanged over the lifetime of the fuel injector; c) the shape of the interface remains a well-defined conical portion; and d) setback 112 affords a sharp corner to fuel flowing along surface 104′, as well as a rapid expansion in annular flow cross-sectional area, thereby imparting substantially increased turbulent kinetic energy to the fuel, which aids in spray control and fuel atomization.

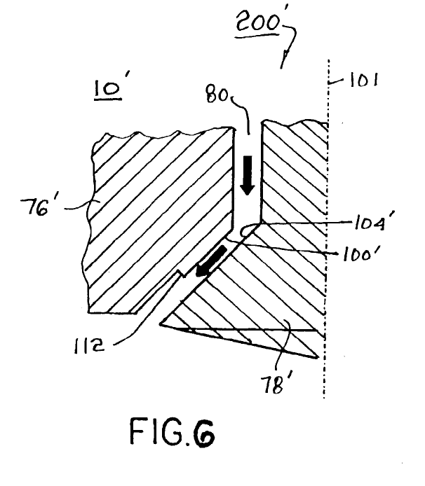

Referring to FIG. 6, setback 112 alternatively may be formed in seat surface 100′ to substantially equal effect, as shown in second embodiment 200′ of an improved metering assembly. Currently, it is preferred to provide setback 112 in the valve head for ease in manufacturing.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A metering assembly for an outwardly-opening fuel injector for injecting fuel into a cylinder of an internal combustion engine, comprising:
a) a valve seat having a first conical sealing surface having a first cone angle; and
b) a valve head having a second conical sealing surface having a second cone angle for mating with said first conical surface,
wherein said first and second cone angles are identical such that said first and second sealing surfaces are parallel, and
wherein the frustum length of one of said first and second sealing surfaces is limited by an annular undercut in said surface to define and limit the frustum length of a mating interface between said first and second sealing surfaces.

2. A metering assembly in accordance with claim 1 wherein said limited frustum length is between about 0.25 mm and about 0.30 mm.

3. An outwardly-opening fuel injector for injecting fuel into a cylinder of an internal combustion engine, the fuel injector comprising a metering assembly having
a valve seat having a first conical sealing surface having a first cone angle, and
a valve head having a second conical sealing surface having a second cone angle for mating with said first conical surface,
wherein said first and second cone angles are identical such that said first and second sealing surfaces are parallel, and
wherein the frustum length of one of said first and second sealing surfaces is limited by an annular undercut in said surface to define and limit the length of a mating interface between said first and second sealing surfaces.
